(19) United States
(12) Patent Application Publication
(10) Pub. No.: US 2005/0168352 A1
(43) Pub. Date: Aug. 4, 2005

(54) Citation free parking method

(76) Inventor: Natan Tomer, Tel Aviv (IL)

Correspondence Address: Tipton L. Randall, 19371 55th Avenue, Chippewa Falls, WI, 54729, US

(21) Appl. No.: 11/034,264

(22) Filed: Jan. 12, 2005

Related U.S. Application Data
(60) Provisional application No. 60/539,007, filed on Jan. 26, 2004.

(51) Int. Cl. G06K 15/00; B60Q 1/48

(52) U.S. Cl. 340/932.2; 235/378; 705/13; 705/418

(57) ABSTRACT

The invention is a method for charging a toll for parking with minimal inconvenience for the user, where the user pays a set fee each time the vehicle is sensed occupying a parking location. In one embodiment, the novel method eliminates the need for any hardware inside the vehicle and makes use of standard communication technology systems to improve and simplify user parking along city streets. A method of monitoring parked vehicles to assure compliance with toll parking regulations is also disclosed. A camera device, having optical character recognition capabilities, photographs vehicle indicia and transmits data to, and receives data from, a remote central control unit to ensure vehicle compliance with regulations. The photograph provides confirming evidence should a user dispute billing for parking on a particular date and time.

### CROSS-REFERENCE TO RELATED APPLICATIONS, IF ANY

This application claims the benefit under 35 U.S.C. $119 (e) of co-pending provisional application Ser. No. 60/539,007, filed 26 Jan. 2004. Application Ser. No. 60/539,007 is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### FIELD OF THE INVENTION

The present invention relates to a method of monitoring and charging a fee for parking a vehicle in a toll parking location and, additionally, to a method of determining if a vehicle is in violation of the requirements for use of the parking location. The present invention provides city monitoring and gathering of statistical information for official city agencies about vehicles with outstanding violations, stolen vehicles, out of date vehicle registration, etc.

### BACKGROUND OF THE INVENTION

Conventional parking meters are widely used to control vehicular parking and to encourage maximum turnover of limited parking areas. These parking meters also provide a substantial source of income to the municipality or other organization using such meters. Drawbacks to these meters include high initial investment costs, high maintenance costs, and high collection costs, all complicated by vandalism and pilferage. The user also encounters various drawbacks when using conventional parking meters. Does the user have coins for the meter? Is the time ordered by inserting coins sufficient to cover the time the user is away from the vehicle? Upon return to the vehicle, the remaining time on the meter cannot be reclaimed. No receipt or record of the parking expense is available.

Alternatively, a number of municipalities have adopted the use of parking coupons. The coupons have tear out or scratch and reveal sections which indicate the date and the expiration time of a particular parking period, the coupons being displayed from the inside of the vehicle by wedging the coupon into the upper end of a closed window. However, these coupons have not been found entirely satisfactory in many locations because of illegal tampering with them for more than one use. Additionally, dividing the city into many parking zones, with each zone requiring a specific coupon, is impractical. Further, there is no incentive to minimize the duration a vehicle occupies the parking location, that is, such a system does not encourage short term parking.

Applicant, in U.S. Pat. No. 4,717,815, has described a time metering device that is useful as a prepaid parking card. The device is a unitary electronic card purchased in advance by the user to provide a pre-purchased time period that may be used whenever desired by the user for parking his vehicle. The card has buttons to select the type of parking zone required, a timer clock showing the amount of purchased time remaining on the card, and switches to start and stop the timer clock. Thus, the user pays for only the actual time that a vehicle occupies a parking space. The card device is displayed within the vehicle during the time the vehicle occupies the parking location. Various other features of the parking card are also disclosed. However, it is desirable to provide a parking monitoring and fee assessment system that requires no special devices by the user. To this end, applicant has devised a unique method of monitoring and charging a fee for parking a vehicle in a toll parking location. The method further provides means for detecting that a parked vehicle is in violation of the requirements for the toll parking location.

More recently, in U.S. Pat. No. 6,243,029, applicant has described method of monitoring and charging a real time fee for parking a vehicle in a toll parking location. Indicia for a toll parking location are provided, as are unique indicia for a vehicle to be positioned in that parking location. The user notifies a remote central control unit the location indicia, the vehicle unique indicia, and the start time of parking the vehicle in the location. Later, the user notifies the remote central control unit the vehicle unique indicia, and the finish time of parking the vehicle in the location. The remote central control unit then assesses a fee to the user for the duration of time the vehicle occupied the parking location.

Recently, applicant has invented a method of monitoring and charging parking fees for a vehicle parked in a toll parking location that requires minimal or no effort on the part of the user, and at the same time, relieves him/her from the burden and the threat of ever receiving a parking ticket. It is a ticketless parking system that guarantees payment to the municipality. The scope and breath of the present invention are set forth in the following description and claims.

### SUMMARY OF THE INVENTION

The invention is a method of monitoring and charging a fee for parking a vehicle in a toll parking location. The invention includes providing unique identification for a vehicle to be positioned in a toll parking location, the unique identification detectable from exterior the vehicle. A database is assembled containing the unique identification data for association with each of a plurality of vehicles. A plurality of toll parking locations is provided, each location correlated with a toll charge per selected unit of time. Once per selected unit of time, the unique identification of vehicles parked in the toll parking location is sensed with an identification sensing device. The data for the unique identification of vehicles parked in the toll parking location is transmitted or downloaded to a remote central control unit by the sensing device. A fee is charged by the remote central control unit, via the database containing unique identification data, to the user for each unique identification-sensing occurrence for a vehicle parked in the toll parking location. Alternatively, the database is carried on-board the sensing vehicle, minimizing the downloading of data to the central control unit.

To monitor the vehicles occupying a toll parking location, a controlling individual, equipped with a small electric vehicle, roams the city streets, sensing the unique identification of a vehicle parked in the toll parking location with a sensing device. The unique identification may include a license plate, a sticker, or a transponder that emits a detectable signal. The sensing device may include a camera having optical character recognition capability, commonly termed LPR (license plate recognition) and ANPR (automatic number plate recognition), or the sensing device may include a receiver for detecting the transponder signal. The sensing device stores the data for each vehicle sensed in an on board computer and later downloads to the remote central control unit the data for the unique identification of the vehicle parked in the toll parking location. The data may be digital or in full picture format. For those vehicles illegally parked, the camera feature of the sensing device may produce a pictorial record of the vehicle in violation of the toll parking location requirements.

In a further embodiment of the invention, a unique location identification is associated with a vehicle parked in a toll parking location upon sensing the unique identification of the parked vehicle. The unique location identification is determined via a Global Positioning System (GPS) unit in association with the identification-sensing device. The parking location identification is used to generate available parking space information that can be accessed by users to find a toll parking location in a particular area.

The above summary of the present invention is not intended to describe each illustrated embodiment or every implementation of the present invention. The detailed descriptions that follow more particularly exemplify these embodiments.

### BRIEF DESCRIPTION OF THE DRAWINGS

FIG. 1 shows a schematic representation of the customer car unit with unique identification, the field control unit with identification sensing device and data storage device, the central control unit with customer database and billing capability, and the customer end user account management application for paying the billing.

### DESCRIPTION OF THE PREFERRED EMBODIMENT

The invention is a method for charging a toll for parking with minimal inconvenience for the user, where the user pays a set fee each time the vehicle is sensed occupying a parking location. The method is convenient for the city officials, removes friction with citizens, and guarantees the city payment for parking. In one embodiment, the novel method eliminates the need for any hardware inside the vehicle and makes use of standard communication technology systems to improve and simplify user parking along city streets and/or parking lots.

The toll parking locations are provided with various designations or indicia, to identify them as a specific zone. Each vehicle to be parked in the toll parking locations is provided with a unique identification, such as a registration number, a license plate number, a sticker, or a transponder that emits a unique identification signal associated with the vehicle. In addition, each vehicle is registered with a remote central control unit so that a parking toll can be charged to the user, preferably with the billing payment guaranteed in advance. The user parks his vehicle in one of the toll parking locations and departs. The operator is now responsible for sensing or “reading” the stickers or the license plate at a quick glance, while traveling or walking along the streets and/or parking lots relatively quickly. A special vehicle, for example, a three-wheeled electric vehicle, which is small and maneuverable like a motorcycle and environmentally friendly, is equipped with a sensing device, such as a camera, a global positioning system (GPS), which is connected or based on GIS city street mapping, as well as a military spec touch sheet portable computer equipped with data card suitable with MMS technology in order to transmit and receive information, where there isn't a 3G network, GPRS is used over GSM. The sensing vehicle travels a given route and scans vehicles bearing the unique identification. The sensing vehicle traverses the given route over a selected time period. For example, the selected time period is one hour, and the toll parking locations on that route have a toll rate of one monetary unit per hour. A one hour time period is used for the selected unit of time in this description, although shorter or longer time periods can be specified at the parking location and within the billing system.

On average, the sensing vehicle monitors each toll parking location once per hour. Thus, statistically, cars parking for a short time will likely not pay at all and, on average (monthly), cars pay less than the time actually parked. Upon each monitoring or sensing occurrence, the unique identification is sensed from exterior the parked vehicle. For example, the sensing vehicle easily reads a special sticker, placed on the topside of the rear window or the top part of the rear side window for easier, closer sensing, automatically.

The billing is simplified. Each time a vehicle is sensed in a toll parking location, a one-hour charge applies. Thus, the “scooter sensor” vehicle makes a full round trip over the route during about one hour. The sensor vehicle will likely miss quite a few users, since vehicles may have entered and left the toll parking location before the sensing vehicle monitors that particular location. Revealing the location of the sensing vehicle, for example, by cell phone (RF signal by SMS) encourages shorter stays and higher turnover rates. This is acceptable because, a) the present invention supports short stays, helps city parking turnover and functions similar to real time parking, but not identically; b) the present invention charges a minimum of one hour every time the sensing vehicle monitors the parked vehicle. This feature is similar to a coupon system and a parking lot where users pay a minimum fee for any entry. One way of looking at the system is, as if, the whole city is one big parking lot. So, the present invention may charge for a full hour, even though the stay was shorter than one hour, but statistically people will pay less.

Preferably, the city is usually divided into zones with parking duration time limits and a cost of parking per minute or hour designated for each zone. The system operator is responsible for dividing the sensing forces to these territories such that each sensing vehicle efficiently makes a selected route or cycle to sense all parked vehicles with proper identification about once an hour, or half an hour, or 2 hours, in accordance with the city zone limit.

The remote central control unit charges the user a fee for each sensing occurrence where the vehicle occupied a parking location. The remote central control unit is a billing system, preferably a computer system operated by the municipality, or an operator on behalf of the municipality, or even a private parking authority. The parking fee may be collected in various manners. At the discretion of the vehicle user upon his registration initiation and his signature, the fee is paid once a month and is automatically charged to the user's private bank account, which the user supplied and agreed to pay in advance. Alternatively, the fee is added to a utility or telephone bill, or is paid by credit card over the telephone, or is paid from a personal banking, parking credit system at the remote central control unit, or through the municipality's parking web portal via credit card. The remote central control unit is located to service a broad area of toll parking within the municipality's borders. The parking system of the present invention is also applicable to private parking facilities.

For parking locations that are in high demand, short time limits and/or higher rates are imposed on users that occupy these high demand parking locations. For example, a vehicle is charged a certain rate, X, for the first time period of parking, then charged 1.5× for the next consecutive time period of parking, and 2.0× for the third consecutive time period of parking, and so forth. This parking rate structure imposes a modest penalty on the user, and encourages turn over of vehicles using the high demand parking locations. Further, users can access the availability of the high demand parking locations through the remote central control unit, thereby providing easier access by users to available toll parking locations. An accurate estimation as to parking occupancy is available by automatically measuring (with the sensing devices) the gap, or the distance, between cars in the toll parking location along the routes of the sensing vehicles. Gaps larger than certain lengths are calculated as parking spaces. The central control unit may provide such information via the Internet over PDA's or other hand held, online devices, with domain names such as: Call2park.com, PhotoParking.com, or Parkulator.com.

Thus, the remote central control unit includes a multi-integrated interactive database capable of calculating parking intervals and monitoring and managing parking transactions. The remote central control unit executes parking orders from individual users, sends verification to parking officers and stores evidence of illegal parking for use in traffic courts. The remote central control unit can adjust parking rates and location time limits according to the municipality's regulations. The remote central control unit continuously gathers extensive data on parked vehicles and the influx and departure of vehicles from the controlled parking areas. The data can be used for informing other drivers of parking location availability as described above, as well as statistics of parking location use to improve city parking zone configurations. This data can also be used (with or without additional payment) by other official agencies.

Monitoring of vehicles parked in toll parking locations is achieved by parking officers using, for example, special automated cameras with proper illumination (such as infrared) to verify the authenticity of the parked vehicles. A device, such as a digital camera, with optical character recognition (OCR) capability is employed to scan the license plate (unique identification) or the parking sticker (or both for fraud) of a vehicle parked in the toll parking location. The digital camera device converts the license plate characters to a digital format (or even ASCI code) and transmits the digital data for the vehicle license plate to the remote central control unit to verify the user is contained in the user database. The device may include a keyboard or touch screen for verifying or correcting the license plate characters. The data transmittal and reception by the digital camera device is by wireless communication, for example by cellular signal. Alternatively, the data stays onboard the traveling sensor vehicle computer for later downloading at the end of the work period. Preferably, the traveling sensor vehicle computer can receive online information of new users that just joined the system, or users who are no longer in the system, while the sensor vehicle is traveling on a route. The digital camera device then receives confirmatory data from the remote central control unit on that particular vehicle.

In an alternative embodiment, the camera device transmits the license plate full image to the central control unit where the plate indicia are converted to a digital format for verification, as described above.

The central control system will not charge twice in the same hour, even if the location is visited twice. The “scanning vehicle” carries the data for all system participants and new data at all times. The central control system can, however, charge a different rate for any subsequent hour, which can be cheaper or more expensive. Because a vehicle can move from one zone in the city to another zone, potentially, it may be sensed twice in the same hour in different zones, with a different cost per hour and a different length of stay. The central control system will be able to know all this at the end of the day since, through the GPS data, the control system knows in which zone/street the vehicle was parked. At the end of the work shift, all sensing vehicles return to base (the central control system) to down load data and upload data to make billings and receive new registration updates for next work shift.

In a further embodiment of the invention, an optional payment system may be administered to special types of vehicles, such as delivery type trucks. In this instance, and since these vehicles make a lot of stop and go actions, the control system may even remove this burden and charge a flat monthly fee for such vehicles. In this situation, all the sensing device operator does is note the validity of the vehicle sticker and recognize in the billing software that this vehicle, even if “caught” once, still pays the full monthly fixed charge. In the future, the central control system may identify other types of vehicles that pay only on a monthly basis, or totally waive costs, depending on the time of day and type of user, for example, local residents, emergency vehicles, police, etc.

In a further embodiment of the invention, the camera device includes a GPS feature that associates the vehicle identification with the occupied parking location, via the GPS. Both vehicle identification and parking location can thus be transmitted to the remote central control unit or stored in the camera device for future reference.

Although the sensing device of the present invention is described as a digital camera device, other imaging devices are contemplated. The devices include video type cameras, or digital and other “still” type imaging devices.

The remote central control unit is the heart of the system, as well as the billing system. All potentially parked cars are registered at the remote central unit upon the user's request. All billing is handled through the remote central unit. Court evidence is generated for use in cases where the user disputes the billing or parking violation for a particular date and time. The user may say “I never came to town this day, why did you bill or ticket me?” The system provides proof in the form of a picture of his vehicle parked in the space on that specific day and time. The emphasis of the system is on “Citation Free Parking” for the users. The system relieves the registered users of the concern that their vehicle will receive a parking citation when parking within a particular municipality while carrying a valid sticker.

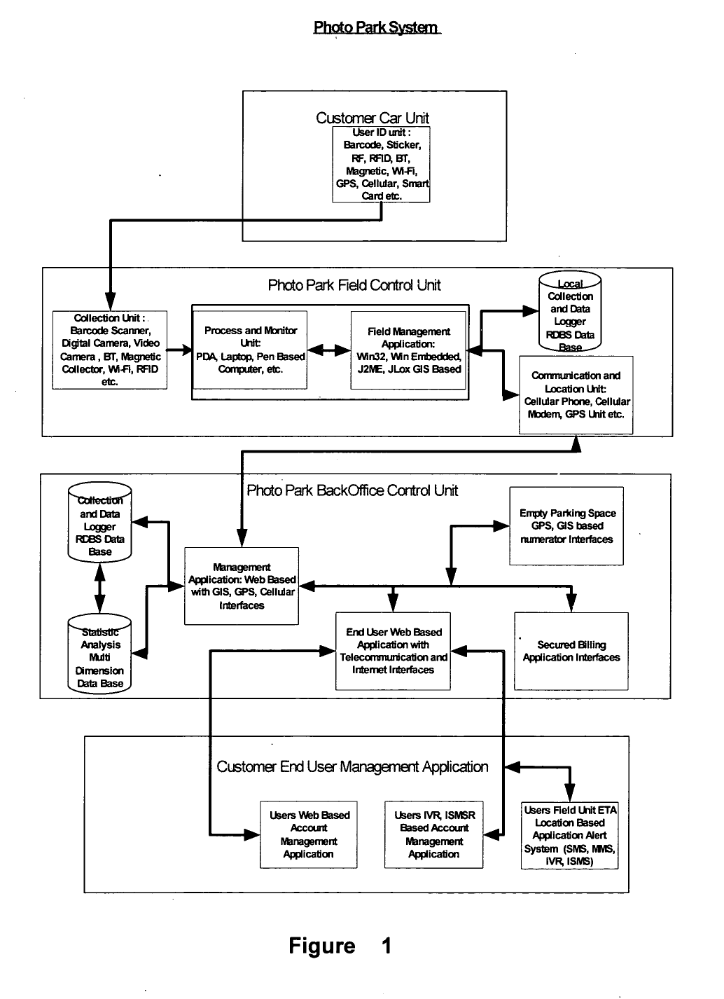

Referring to FIG. 1, a schematic representation of the customer car unit with unique identification, the field control unit with an identification-sensing device and a data storage device, the central control unit with a customer database and billing capability, and the customer end user account management application for paying the billing, is shown. The parked vehicle, denoted as the car unit, contains a unique identification, or user ID unit. The identification unit can be a barcode sticker, an RFID, or other type transponders, a magnetic tag, a wireless fidelity (Wi-Fi) unit, a GPS unit, a cellular phone, or a “smart card” device containing identification information.

The field control unit traveling past the parked vehicle employs an identification-sensing device capable of reading or sensing the user ID unit. The sensing device is compatible with the identification unit and can be a barcode scanner, an RF receiver, a magnetic tag collector or reader, a digital camera, a video camera or a wireless fidelity (Wi-Fi) unit. The identification data is stored in a process and monitor unit, such as a Personal Data Assistant (PDA), a laptop computer, or similar data storage device. The data is managed in the field using, for example, Win32 or a Win-embedded GIS base application, and can be transferred to a local collection and data logger database, or communicated to the remote central control unit using a cellular phone, a cellular modem, or a GPS unit.

The remote central control unit manages the field data in several large databases and generates a billing to the end user, that is, the owner or individual parking the vehicle. The control unit provides access to the users via a telecommunications, mail, and Internet interface, where the users can pay their billing. The telecommunications and Internet interface with the central control unit also is used to determine parking space availability in real time at the existing destination. An accurate estimation as to parking occupancy is available by automatically measuring (with the sensing devices) the gap, or the distance, between cars in the toll parking location along the routs of the sensing vehicles.

As described above, the basic system is not a parking ticket/violation solution. Tickets can be issued by the system, but typically, as long as a vehicle has a valid sticker it is simply charged for the hour. However, since the sensing device includes a computer with all the data for valid users, the operator may encounter “bad” stickers in which; a) they may not be in the data base, b) the sticker does not match the license plate, c) the sticker is tampered and forged, etc. In these cases, a message is sent to the parking patrol to advise them of the exact location of this vehicle for interrogation and for issuing a ticket or citation, a clamp, tow away, etc.

While the present invention has been described with reference to several particular example embodiments, those skilled in the art will recognize that many changes may be made thereto without departing from the spirit and scope of the present invention, which is set forth in the following claims.

1. A method of monitoring and charging a fee for parking a vehicle in a toll parking location comprising the steps;
(a) providing unique identification for a vehicle to be positioned in a toll parking location, the unique identification detectable from exterior the vehicle;
(b) assembling a database containing unique identification data for association with each of a plurality of vehicles;
(c) providing a plurality of toll parking locations, each location correlated with a toll parking charge per selected unit of time;
(d) sensing with an identification-sensing device, once per selected unit of time, the unique identification of vehicles parked in the toll parking location; and
(e) charging a fee to a user for each unique identification-sensing occurrence for a vehicle parked in the toll parking location employing the unique identification data of the database.

2. A method of monitoring and charging a fee for parking a vehicle in a toll parking location according to claim 1, wherein the unique identification is visible from external the vehicle and the sensing device is an optical character recognition device.

3. A method of monitoring and charging a fee for parking a vehicle in a toll parking location according to claim 1, wherein the unique identification for the vehicle includes a registration sticker visible from exterior the vehicle.

4. A method of monitoring and charging a fee for parking a vehicle in a toll parking location according to claim 1, wherein the unique identification for the vehicle includes a license plate visible from exterior the vehicle.

5. A method of monitoring and charging a fee for parking a vehicle in a toll parking location according to claim 1, wherein the unique identification for the vehicle includes a transponder secured to the vehicle for identification thereof, and the identification sensing device is a transponder signal detector.

6. A method of monitoring and charging a fee for parking a vehicle in a toll parking location according to claim 1, further including the step of:
(f) associating a unique location identification with a vehicle parked in a toll parking location upon sensing the unique identification of the parked vehicle.

7. A method of monitoring and charging a fee for parking a vehicle in a toll parking location according to claim 6, wherein the unique location identification is determined via a global positioning system (GPS) unit in association with the identification sensing device.

8. A method of monitoring and charging a fee for parking a vehicle in a toll parking location according to claim 7, wherein the global positioning system (GPS) unit is associated with a GIS-type city street map to provide an address associated with each sensing occurrence.

9. A method of monitoring and charging a fee for parking a vehicle in a toll parking location according to claim 1, wherein the unique identification data includes vehicle information, a user name and a user billing information.

10. A method of monitoring and charging a fee for parking a vehicle in a toll parking location according to claim 1, wherein a maximum fee is charged to a user upon a first unique identification sensing occurrence for a vehicle parked in a toll parking location for a selected unit of time, with no additional fee charged upon each subsequent unique identification sensing occurrence during the selected unit of time.

11. A method of monitoring and charging a fee for parking a vehicle in a toll parking location comprising the steps;
(a) providing unique identification for a vehicle to be positioned in a toll parking location, the unique identification detectable from exterior the vehicle;
(b) assembling a database containing unique identification data for association with each of a plurality of vehicles;
(c) providing a plurality of toll parking locations, each location correlated with a toll parking charge per selected unit of time;
(d) sensing with an identification-sensing device, once per selected unit of time, the unique identification of vehicles parked in the toll parking location;
(e) charging a fee to a user for each unique identification sensing occurrence for a vehicle parked in the toll parking location employing the unique identification data of the database; and
(f) associating a unique location identification with a vehicle parked in a toll parking location upon sensing the unique identification of the parked vehicle

12. A method of monitoring and charging a fee for parking a vehicle in a toll parking location according to claim 11, wherein the unique identification is visible from external the vehicle and the sensing device is an optical character recognition device.

13. A method of monitoring and charging a fee for parking a vehicle in a toll parking location according to claim 11, wherein the unique identification for the vehicle includes a registration sticker visible from exterior the vehicle.

14. A method of monitoring and charging a fee for parking a vehicle in a toll parking location according to claim 11, wherein the unique identification for the vehicle includes a license plate visible from exterior the vehicle.

15. A method of monitoring and charging a fee for parking a vehicle in a toll parking location according to claim 11, wherein the unique identification for the vehicle includes a transponder secured to the vehicle for identification thereof, and the identification sensing device is a transponder signal detector.

16. A method of monitoring and charging a fee for parking a vehicle in a toll parking location according to claim 15, wherein the unique location identification is determined via a global positioning system (GPS) unit in association with the identification sensing device.

17. A method of monitoring and charging a fee for parking a vehicle in a toll parking location according to claim 16, wherein the global positioning system (GPS) unit is associated with a GIS-type city street map to provide an address associated with each sensing occurrence.

18. A method of monitoring and charging a fee for parking a vehicle in a toll parking location according to claim 11, wherein the unique identification data includes a user name and a user billing information.

19. A method of monitoring and charging a fee for parking a vehicle in a toll parking location comprising the steps;
(a) providing unique identification for a vehicle to be positioned in a toll parking location, the unique identification detectable from exterior the vehicle;
(b) assembling a database containing unique identification data, including a user name and a user billing information, for association with each of a plurality of vehicles;
(c) providing a plurality of toll parking locations, each location correlated with a toll parking charge per selected unit of time;
(d) sensing with an identification-sensing device, once per selected unit of time, the unique identification of vehicles parked in the toll parking location;
(e) charging a fee to a user for each unique identification sensing occurrence for a vehicle parked in the toll parking location employing the unique identification data of the database; and
(f) associating a unique location identification with a vehicle parked in a toll parking location upon sensing the unique identification of the parked vehicle.

20. A method of monitoring and charging a fee for parking a vehicle in a toll parking location according to claim 19, wherein no citation is issued to a vehicle having said unique identification when parked in one of said plurality of provided toll parking locations.
